(19) United States
(12) Patent Application Publication
(10) Pub. No.: US 2012/0105180 A1
(43) Pub. Date: May 3, 2012

(54) ELECTROMAGNET FOR MOVING TUBULAR MEMBERS

(76) Inventor: Danilo Molteni, Manerbio (IT)

(21) Appl. No.: 13/381,801

(22) PCT Filed: Jul. 1, 2010
(86) PCT No.: PCT/EP2010/059412

§ 371 Date: Dec. 30, 2011

(30) Foreign Application Priority Data
Jul. 13, 2009 (IT) MI2009A001241

(51) Int. Cl. H01F 7/08

(52) U.S. Cl. 335/255

(57) ABSTRACT

A novel electromagnet for moving tubular members is described, in which the flux lines extend only downwards in the direction of the load whereas the laterally dispersed magnetic field is substantially absent. The polar yoke of such an electromagnet has two North polarity cores on which two solenoids are wound, protected on the bottom by annular baffles made from non-magnetic material, and side panels made from ferromagnetic material extend along both sides and pass next to the two cores magnetically connecting the three South polarity poles, the side panels being magnetically insulated from the two cores. The thickness of the side panels is sized such that they are suitable to short-circuit the whole lateral flux preventing the dispersion thereof and conveying it completely towards the polar shoes of the three poles and into the material to be magnetized thus actively contributing to the lifting of the latter.

The present invention relates to electromagnets used in apparatuses for moving tubular members and bundles of tubes, and in particular to an electromagnet provided with a structure that substantially eliminates the laterally dispersed magnetic field.

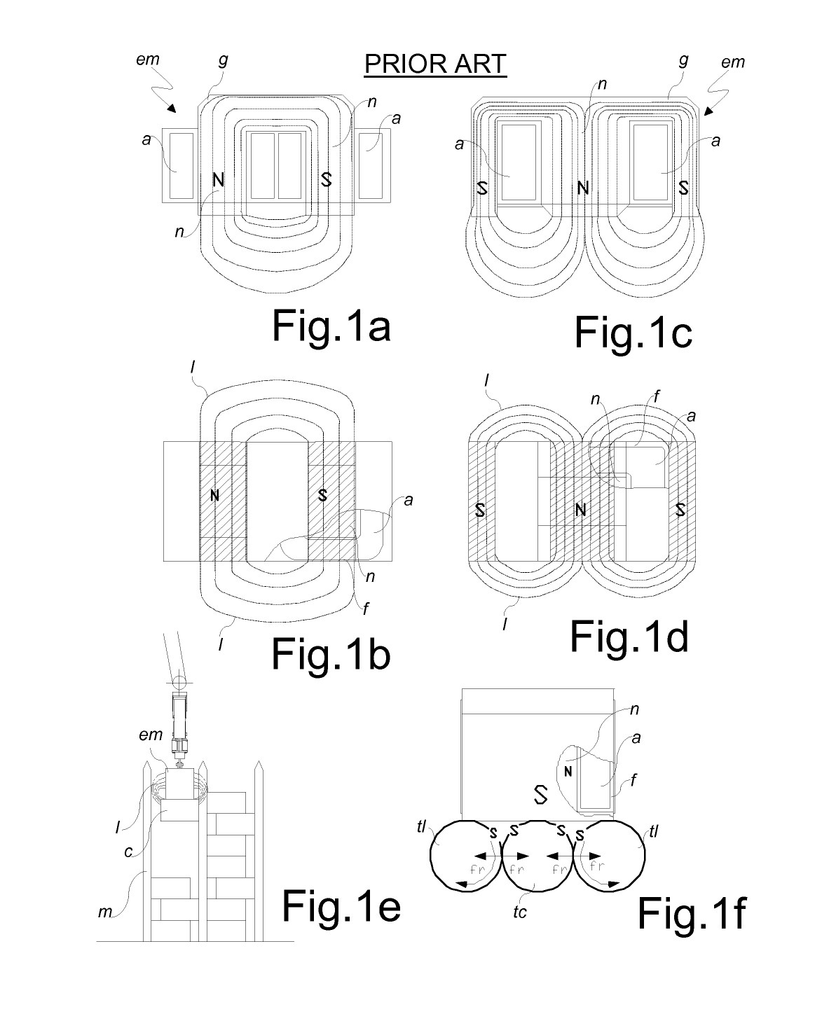

It is known that the electromagnets normally used for these apparatuses have a polar yoke shaped like an inverted U with 1 or 2 solenoids wound on the cores and North/South polarities (as illustrated in FIG. 1a), or a polar yoke shaped like an E rotated 90° clockwise with a single solenoid wound on the central core and South/North/South polarities (as illustrated in FIG. 1c). These electromagnets are used in pairs to move tubular members or bundles of tubes from 5 to 8 meters long, or in double pairs (i.e. 4) for lengths between 6 and 18 meters.

To move this type of load, the electromagnets are mounted on overhead travelling cranes manually guided by operators who meet significant difficulties in moving the load precisely, said difficulties being mainly due to the strong laterally dispersed magnetic field that such a type of electromagnets generates (as illustrated in FIG. 1b and FIG. 1d). In fact, the sides of conventional electromagnets, due to the shape of the polar yokes, are made from stainless or manganese steel or other material that is necessarily non-magnetic and therefore orthogonally permeable to the dispersed flux lines passing through it.

This laterally dispersed field makes it difficult to center the load in the proximity of ferromagnetic members such as other loads or stalls or metal side planks of transport means because, during the load transfer phase, the electromagnets are laterally deviated by the attractive effect towards said members caused by said dispersed field (see FIG. 1e).

This occurs even if the electromagnets are fed through adjustment systems suitable to generate the magnetomotive force corresponding to the minimum operational limit. As a consequence, the moving is slow and difficult, the loads can not be correctly stacked and it is substantially impossible to use automatic moving systems since the lateral deviations always make necessary for an operator to provide a corrective intervention.

A further drawback of conventional electromagnets, which occurs when moving bundles of tubes kept together by containment strappings, are the repulsive forces that are generated between two adjacent tubes (as illustrated in FIG. 1f) and discharged onto the strappings that tend to be deformed. In fact, since the electromagnets are arranged longitudinally on the bundle of tubes to be moved, the magnetically active regions (indicated by hatched areas in FIGS. 1b, 1d) are arranged transversally with respect to the tubes, whereby the underlying tube surfaces are all polarized with the same sign thus tending to repel each other due to the repulsive effect and, consequently, to rotate the two external tubes in opposite directions with possible damages to the tube surfaces.

These deformations of the strappings make it even more difficult to use automatic systems since the size of the bundle of tubes is changed, and the changes in multiple stacked bundles add up with the result that the theoretical coordinates calculated by the automatic system do not correspond to the actual position of the bundle to be moved.

Still another drawback of known electromagnets is the particularly high ratio between the overall exerted force and the limited active surface that contacts the load, the latter being not more than 50% of the plan surface area of the electromagnet (see hatched areas in FIGS. 1b, 1d). Therefore, the combination of the great weight of the electromagnets with the magnetic attractive force distributed over a limited surface results in a high specific pressure on the load that can damage the surface thereof, especially in the case of small-thickness members.

U.S. Pat. No. 4,847,582 discloses a magnetic gripping apparatus comprising an external ferromagnetic yoke having a base plate and peripheral walls; four pole units each comprising a main pole piece having an outer face defining a gripping surface; three intermediate pole members, each arranged between two adjacent pole units, said intermediate pole members extending from the base plate to said gripping surface; permanent magnets arranged between the main pole pieces and the base plate and an electrical winding encircling the magnets between the main pole pieces and the base plate, said permanent magnets, in the activated condition of the apparatus, providing a pole distribution of the gripping surface in which two adjacent pole units or respectively one of the pole units and one of the adjacent intermediate pole members exhibit poles of opposite polarity on their outer faces.

In this way, an intermediate pole member, which is not usually fed by any magnetic source and merely constitutes a short-circuiting member between adjacent pole units when gripping large-sized workpieces, is automatically activated to conduct the magnetic flux generated by a given one of the pole units towards the gripping surface, so as to generate a pole, or “false pole”, having a polarity opposite to that of said given pole unit, whenever the dimensions and/or disposition of the workpieces to be gripped are such as to prevent short-circuiting or contact with two adjacent pole units of opposing polarity. Otherwise, said intermediate pole member operates as a wholly neutral element which is magnetically inactive towards the workpiece gripping surface and contributes merely to support the workpieces to be gripped. This dual function of the intermediate pole member, which in fact causes a variation in the pole pitch, occurs wholly automatically in relation to the different lengths or dimensions of the metal workpieces to be gripped.

This document therefore relates to a permanent-magnet apparatus which is deactivated by complete demagnetization, said apparatus comprising a base plate and peripheral walls together defining a ferromagnetic yoke inside which are disposed four pole units with alternate North/South/North/South polarities. Each pole unit is substantially composed of a ferromagnetic element or main pole piece, one face of which ends in correspondence with the gripping surface, and of a core of magnetic material surrounded by an electrical coil, both of which are disposed coaxially to the magnetic core which is in contact between the upper ferromagnetic element and the base plate.

Such a known apparatus still suffers from the drawbacks mentioned above, since it does not effectively prevent the lateral dispersion of the magnetic field, causes the repulsive effect on the polarized tubes since the peripheral walls form a single yoke with the base plate and are not magnetically insulated from the magnetic cores, whereby the tubes are all polarized with the same sign, and has a small active surface corresponding to the outer surface of the main pole pieces or some of the pole pieces and an intermediate pole member when the load is shorter than the gripping apparatus.

Therefore the object of the present invention is to provide an electromagnet which overcomes the above-mentioned drawbacks. This object is achieved by means of an electromagnet formed by at least two E-shaped electromagnets aligned and provided with ferromagnetic side panels magnetically insulated from the cores and magnetically connected to the polar shoes of the poles, said panels being sufficiently thick as to short-circuit the lateral flux of the magnetic field thus preventing the dispersion thereof and conveying it towards said polar shoes of the poles. Other advantageous features are recited in the dependent claims.

The main advantage of an electromagnet according to the present invention is that, both in the presence and in the absence of a load, the laterally dispersed flux is practically nothing so as to allow a precise moving of the load to the desired position without undergoing deviations caused by other ferromagnetic members nearby. It is therefore possible to perfectly match the coordinates programmed in a overhead travelling crane or transport truck, which can be operated even in an automatic manner without the presence of an operator.

A second important advantage of the present electromagnet results from the fact that, when moving bundles of tubes, the flux lines at the cores that exit the cores and close into the side panels not only eliminate the lateral dispersions but also create an attractive force between adjacent tubes since the polarities generated on the tube surfaces are of opposite signs. As a consequence, these attractive forces tend to compensate for the repulsive forces generated between adjacent tubes at the head panels where the magnetically active regions have a same sign, as previously explained, thus substantially dispensing with the risk of deformation of the containment strappings and therefore allowing for the use of automatic systems also for moving bundles of tubes.

Still another significant advantage of the above-mentioned electromagnet resides in the large area of the active surface contacting the load with respect to the total plan surface area of the electromagnet. This results in a specific pressure, for the same force of magnetic attraction, which is much lower than that of conventional electromagnets and this decreases the possibility of damaging the load surface, in particular of small-thickness tubes.

Finally, a further advantage of such an electromagnet is given by the fact that, for the same width and load capacity, its greater longitudinal extension allows to reduce its height by half which increases the possibility of storing the load in warehouses and on transport means, in particular when they are provided with ribs.

These and other advantages and characteristics of the electromagnet according to the present invention will be clear to those skilled in the art from the following detailed description of an embodiment thereof, with reference to the annexed drawings wherein:

FIGS. 1a-1f illustrate prior art electromagnets and their drawbacks;

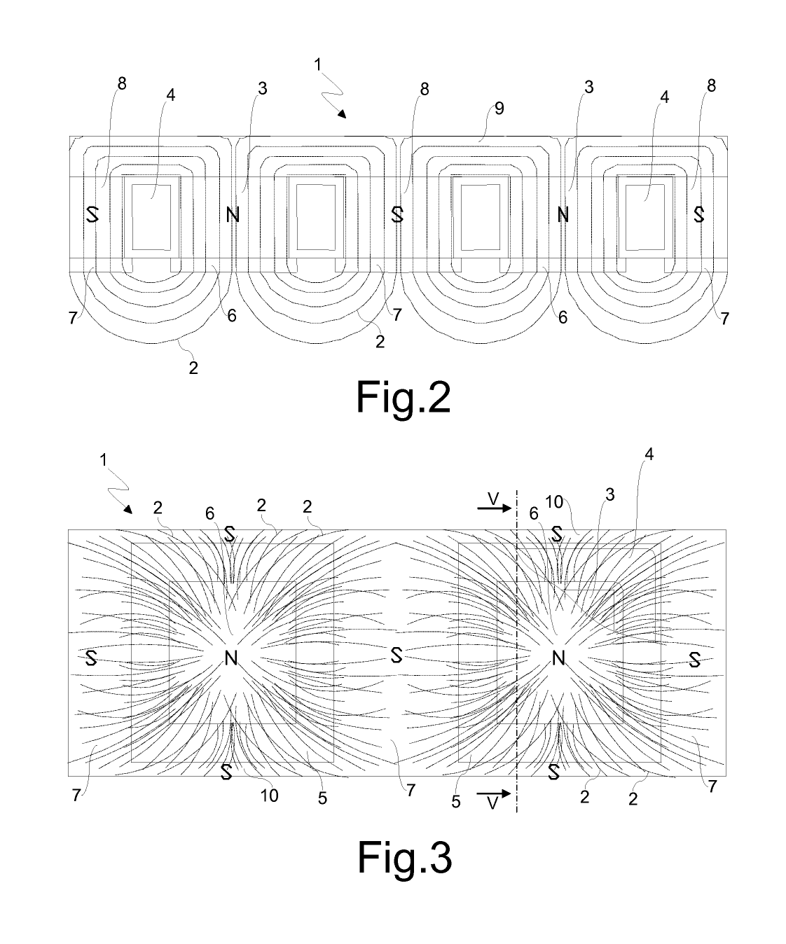

FIG. 2 is a lateral view in longitudinal section along the midplane of an electromagnet according to the invention;

FIG. 3 is a bottom plan view, with a broken-away portion, of the electromagnet of FIG. 2;

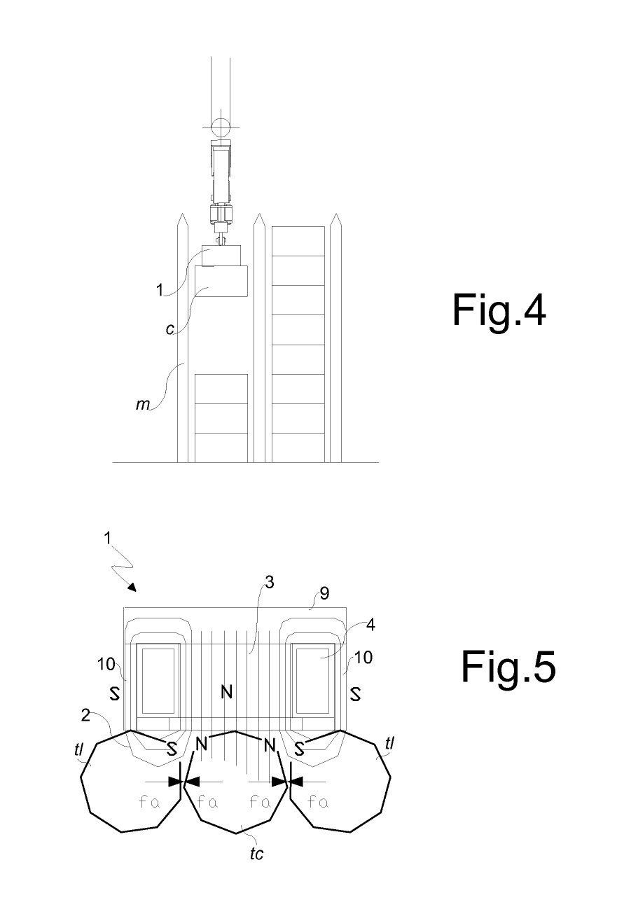

FIG. 4 is a lateral view diagrammatically showing a moving apparatus that uses said electromagnet; and

FIG. 5 is a cross-sectional view along line V-V of FIG. 3.

Referring first to the prior art illustrated in FIGS. 1a to 1f, there is seen that a conventional electromagnet em may be formed by a polar yoke g having an inverted U shape with 2 solenoids a wound on cores n and North/South polarities (as illustrated in FIG. 1a), or an E shape rotated 90° clockwise with a single solenoid a wound on the central core n and South/North/South polarities (as illustrated in FIG. 1c). In both cases, such an electromagnet em has a strong laterally dispersed field l (FIGS. 1b, 1d) since its side panels f are made from non-magnetic material, and this makes difficult to center the load c in the proximity of ferromagnetic members, such as stalls m, because of the lateral deviation caused by the attractive effect towards said members due to said dispersed field l (FIG. 1e).

Moreover, as shown in FIG. 1f, when moving bundles of tubes kept together by containment strappings, repulsive forces fr are generated between adjacent tubes since the tube surfaces, e.g. a central tube tc and two lateral tubes tl, are all polarized with the same sign thus tending to repel each other due to the repulsive effect and, consequently, to rotate the two external tubes tl in opposite directions.

FIGS. 2 and 3 show a novel electromagnet 1 according to the present invention in which the flux lines 2 extend only downwards in the direction of the load to be moved, whereas the laterally dispersed magnetic field is substantially absent.

More specifically, there is seen that the polar yoke of said electromagnet 1 has a shape corresponding to two aligned E-shaped yokes. In fact, there are provided two North polarity cores 3 on which two solenoids 4 are wound, received in suitable recesses, buried in insulating resins and preferably manufactured from copper wire strips in order to achieve the maximum fill factor and to obtain a compact size of the solenoids 4 and consequently of the ferromagnetic circuit formed around them, thus reducing to a minimum the weight and size of electromagnet 1.

Solenoids 4 are protected on the bottom by annular baffles 5 made from non-magnetic material, such as wear-resistant manganese steel, and the flux lines 2 exit from the enlarged polar shoes 6 of the two cores 3, pass through the ferromagnetic material of the load to be moved and re-enter through the faces of three enlarged polar shoes 7 of the South polarity poles 8, finally closing in cover 9 that connects cores 3 to poles 8, all these circuital members being obviously made from ferromagnetic material.

A novel aspect of the present electromagnet is given by the presence of the side panels 10 made from ferromagnetic material extending along both sides and passing next to cores 3 so as to magnetically connect the three poles 8 while being magnetically insulated from cores 3 in order to prevent magnetic short-circuiting. The thickness of the ferromagnetic side panels 10 is sized such that they are suitable to short-circuit substantially the whole lateral flux, therefore preventing the dispersion thereof and conveying it completely towards the polar shoes 7 of poles 8 and into the material to be magnetized thus actively contributing to the lifting of the latter.

In fact, in the present electromagnet 1 the active surface contacting the load consists of the whole bottom surface with the exception of the two annular baffles 5 made from non-magnetic material. As a consequence, a same magnetic attraction force is distributed over a greater surface area, which combined with the reduction in weight of electromagnet 1 results in a low specific pressure on the load surface thus eliminating the risk of surface damage.

The pattern of the flux lines 2 illustrated in FIGS. 2, 3 shows that even in the open field, i.e. without the presence of a load, the laterally dispersed flux is practically nothing. This is an essential aspect for positioning load c in the desired spot with electromagnet 1 without undergoing deviations even in the presence of stalls m of ferromagnetic material, thus perfectly matching the coordinates programmed by an automatic system without requiring the presence of personnel (FIG. 4).

Finally, as shown in the sectional view of FIG. 5, the flux lines 2 exiting the two North polarity cores 3 and closing in the South polarity side panels 10 not only eliminate the lateral dispersions but also create attractive forces fa between the lateral tubes tl and the central tube tc because the polarities that are generated on adjacent active surfaces have opposite signs. This attractive effect increases the anchoring strength under the same conditions with respect to a conventional electromagnet and does not produce an additional load on the containment strappings.

This allows to prevent the deformations of the tube bundles strappings and the subsequent risks of strapping failure and of mismatching of the positioning coordinates. As a consequence, electromagnets 1 according to the present invention can be used to build an automatic warehouse for tubular members, including strapped tube bundles.

It is clear that the above-described and illustrated embodiment of the electromagnet according to the invention is just an example susceptible of various modifications. In particular, the double-E shape with two cores 3, two solenoids 4 and three poles 8 is preferred, yet the addition of further E-shaped modules could be provided to increase the lifting capacity. For example, a larger electromagnet 1 could include three cores 3, three solenoids 4 and four poles 8.

1. An electromagnet comprising:
at least two solenoids each wound on a respective core of a polar yoke, side panels,
bottom baffles for protection of the at least two solenoids,
first polar shoes at the cores of the polar yoke, and
second polar shoes at poles of the polar yoke;
wherein:
the polar yoke has a shape corresponding to at least two aligned E-shaped yokes with at least two cores and three poles,
the side panels are made from ferromagnetic material and magnetically connect the poles while being magnetically insulated from the cores, and
the side panels have a thickness sized such that the side panels are suitable to short-circuit the whole lateral flux of a magnetic field generated by the electromagnet and to convey the lateral flux towards the second polar shoes.

2. The electromagnet according to claim 1, further comprising recesses shaped to receive the at least two solenoids, the solenoids being buried in insulating resins and manufactured from copper wire strips.

3. The electromagnet according to claim 1, wherein the bottom baffles are annular baffles extending between the side panels and the cores.

4. An apparatus for moving tubular members of ferromagnetic material, wherein the apparatus includes one or more electromagnets according to claim 1.

5. The electromagnet according to claim 2, wherein the bottom baffles are annular baffles extending between the side panels and the cores.
